(19) United States
(12) Patent Application Publication
(10) Pub. No.: US 2021/0351477 A1
(43) Pub. Date: Nov. 11, 2021

(54) COMPOSITE SEPARATOR FOR LITHIUM ION BATTERY AND METHOD FOR PREPARING THE SAME, AND LITHIUM ION BATTERY

(71) Applicant: SOUTH CHINA UNIVERSITY OF TECHNOLOGY, Guangzhou (CN)

(72) Inventors: Haihui Wang, Guangzhou (CN); Jian Xue, Guangzhou (CN); Suqing Wang, Guangzhou (CN)

(21) Appl. No.: 17/381,213

(22) Filed: Jul. 21, 2021

Related U.S. Application Data
(63) Continuation of application No. PCT/CN2020/119861, filed on Oct. 7, 2020.

(30) Foreign Application Priority Data
Oct. 17, 2019 (CN) 201910991074.9

(51) Int. Cl. H01M 50/446; H01M 50/403; H01M 4/62; H01M 10/0525

(52) U.S. Cl. CPC H01M 50/446; H01M 10/0525; H01M 4/622; H01M 50/403

(57) ABSTRACT

A composite diaphragm, comprising first particles and second particles, and a binder less than 5 wt %. The first particles and the second particles have different particle sizes of particle compositions, the first particles have a radius of r, and the second particles have a radius of r′, wherein r and r′ meet the following relationship: (2\sqrt{3}/3−1)<(r′/r)<(\sqrt{6}/2−1); the first particles are prepared from at least one or more of egg shells, duck egg shells, goose egg shells, and other bird or amphibian egg shells; the second particles are prepared from shells and abalone shells; a first particle layer, a second particle layer, and the binder are adopted to form a film, an integrated lithium ion battery composite diaphragm material is formed, an inorganic material is not easy to fall off, and a particle material plays a full role.

### CROSS REFERENCE TO RELATED APPLICATION

This application is a continuation of International Application No. PCT/CN2020/119861, filed on Oct. 7, 2020. The International Application No. PCT/CN2020/119861 claims priority to a Chinese patent application No. 201910991074.9, filed on Oct. 17, 2019. The entirety of the above-mentioned applications is hereby incorporated by reference herein.

### TECHNICAL FIELD

This disclosure relates to a composite separator for a lithium ion battery, and more particularly, to a high-performance lithium ion battery composite separator formed by combining inorganic particles and a small amount of organic reagents, the preparation method thereof, and a lithium ion battery.

### BACKGROUND

Lithium ion battery is a potential energy source for electric vehicles and hybrid electric vehicles, but the high price and the safety issues still limit its practical application. The actual cost estimate shows that the cost of the microporous polyolefin separator (such as Celgard separator) account for 25%-30% of the cost of the entire battery material. Moreover, when the temperature reaches 130° C. or higher, the polyolefin separator will soften or even melt, and sharp shrinkage of the volume of the separator will cause an internal short circuit, which results in catastrophic thermal runaway. Therefore, for a high-power lithium ion battery, it is necessary to develop a separator with cheaper price and high thermal stability. Inorganic particles have good electrolyte wettability and excellent high-temperature performance, and are widely used to modify lithium ion battery separators. A common method is to coat inorganic particles on a polymer microporous separator to obtain a multilayer composite separator. The presence of inorganic particles can improve the electrolyte wettability and high-temperature dimension stability of the multilayer composite separator, thereby improving the performance of lithium ion battery. However, the adhesion between the inorganic particle coating and the polymer separator is poor, and the coating is easy to fall off; at the same time, the content of inorganic particles in the multilayer composite separator is relatively low, and the advantages of inorganic particles cannot be fully utilized.

As mentioned in Journal of Power Sources 140(2005)361-364, the separator prepared by using inorganic CaCO3 particles and a small amount of organic binder not only shows good electrolyte wettability, but also can neutralize HF, and the battery assembled by the separator shows good capacity retention and high-rate performance. However, the thickness of the separator is 170-190 um, which is much larger than that of existing commercial separators (25-40 um).

In Acta Materiae Compositae Sinica, 1000-3851(2009)01-0059-06, a composite separator is prepared using amphoteric Al2O3/SiO2 as the main component, the composite separator is used as a lithium ion battery separator, which can interact with acidic by-product HF (hydrogen fluoride) in the electrolyte for lithium-ion battery on site.

In J Appl Electrochem (2016)46:69-76, by bonding of PVDF, AlO(OH) is prepared into a separator of 22 um, the separator shows good electrolyte wettability and thermal stability. However, 25 wt % binder is used, which greatly reduces the porosity of the separator. In Journal of Membrane Science 509(2016)19-26, the binder is replaced with styrene butadiene rubber (SBR) and the mass of the binder is reduced to 6 wt %. Although the electrolyte wettability and retention rate are improved, the maximum mesh number of the inorganic particles Al2O3 used is 300 mesh (48 um), which makes it difficult to obtain a thinner film. For example, CN 106025150 A discloses a battery separator prepared by using egg membranes. However, it is difficult to guarantee the quality of the separator. It is difficult to produce egg membranes in batch and large-scale, the manufacturing technique is difficult to be unified, and it is difficult to obtain products of uniform quality.

For another example, CN 109244318 A discloses: a preparation method of porous aragonite structure micron sheet, the porous aragonite structure micron sheet is separated from a natural shell body and further applied to a diaphragm. However, the diaphragm also requires more modifiers and binders. The use of more modifiers and binders reduces the reliability of the diaphragm, and too much binder reduces the pores of the diaphragm, thereby reducing the performance of the lithium ion battery diaphragm.

### SUMMARY

In a first aspect, the disclosure provides a composite separator for a lithium ion battery, including inorganic particles and a binder, the binder being less than 5 wt % of the composite separator, the inorganic particles consisting of first particles and second particles; wherein the first particles are made of eggshells, the second particles are made of natural organic shells, and the first particles and the second particles meet an expression of: (2\sqrt{3}/3−1)<(r′/r)<(\sqrt{6}/2−1), where r represents a radius of the first particles, r is 20-100 nm, r′ represents a radius of the second particles.

In a second aspect, the disclosure provides a method for preparing a composite separator as for a lithium ion battery, including:

S1, crushing eggshells to first particles, and crushing seashells to second particles, wherein the first particles and the second particles meet an expression of: (2\sqrt{3}/3−1)<(r′/r)<(\sqrt{6}/2−1), where r represents a radius of the first particles, r is 20-100 nm, r′ represents a radius of the second particles;

S2, dispersing 100 parts by volume of the first particles, 2-5 parts by volume of the second particles, and 2-4 wt % binder in deionized water, and ball milling for 5-20 minutes to prepare a paste;

S3, pouring the prepared paste on a glass plate;
S4, drying the paste on the glass plate at 40-70° C. for 2-5 hours thereby forming a composite separator film; and soaking the composite separator film in water for 10-30 minutes after the drying; and

S5, peeling off the composite separator film from the glass plate, and drying the composite separator film at 40-70° C. for 5-20 hours.

In a third aspect, the disclosure provides a lithium ion battery, the lithium ion battery includes the composite separator as described in the first aspect.

### BRIEF DESCRIPTION OF THE DRAWINGS

FIG. 1 is a schematic diagram showing the position and size of the second particles when the first particles are laid.

FIG. 2 is a schematic diagram showing the position and size of the second particles when the first particles are densely stacked.

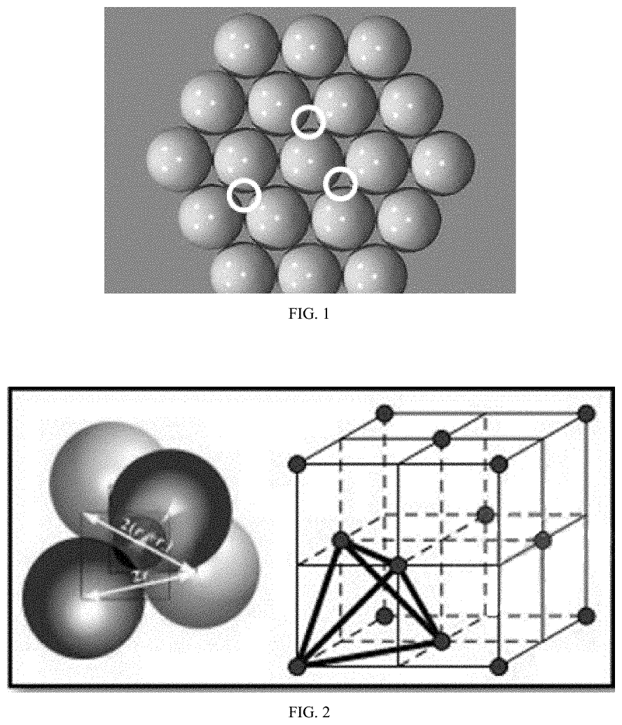

### DETAILED DESCRIPTION OF PREFERRED EMBODIMENTS

The technical problem to be solved by the disclosure is to provide a composite separator for a lithium ion battery, in particular to provide a high-performance lithium ion composite battery separator adopting inorganic particles and a relatively small amount of binder, the preparation method thereof, and a lithium ion battery, so as to solve the problems of insufficient stability, insufficient high temperature resistance, substandard thickness of the inorganic separator of the lithium ion battery in the prior art, and the problem of membrane pore blockage caused by the addition of too much binder.

In an embodiment, the disclosure provides a composite separator for a lithium ion battery. The composite separator includes inorganic particles and a binder, the binder is less than 5 wt % the composite separator, and the inorganic particles consists of first particles and second particles.

Optionally, the first particle and the second particle have different particle sizes.

Optionally, the first particle has a first size, and a particle size of the first particle with the first size is represented by a radius r. Preferably r is 20-100 nm.

Optionally, the first particles are made of one or more of egg shells, duck eggshells, goose eggshells, and other bird/amphibian eggshells.

Optionally, the second particles are natural organic particles with a second size, and a particle size of the second particle with the second size is represented by a radius r′. Preferably, r′ meets a relationship of: (2\sqrt{3}/3−1)<(r′/r)<(\sqrt{6}/2−1). Preferably, a ratio of the volume of the second particles to the volume of the first particles is 2-5:100.

It should be noted that the radius r may be a statistical average of the radii of the first particles; the radius r′ may be a statistical average of the radii of the second particles.

Optionally, the second particles are made of natural organic shells, preferably seashells, and/or abaloneshells.

Optionally, by crushing, ball milling, or grinding, the first particles of a corresponding size r and the second particles of a corresponding size r′ are obtained.

Optionally, the first particles and/or the second particles are modified by dipping, coating, etc. after being crushed and ball milled to a specified diameter range.

Optionally, the first particles are laid to form a first particle layer, and the second particles are embedded in the interspaces of the laid or densely stacked first particles, and the radii meet the relationship of: (2\sqrt{3}/3−1)<(r′/r).

Optionally, the first particles are densely stacked, and the radius of the second particles meets the relationship of: (r′/r)<(\sqrt{6}/2−1). Preferably, the amount of the binder is not more than 5 wt %, and the binder is preferably an amphoteric binder, preferably amphoteric polyacrylamide.

In an embodiment, the disclosure provides an application of the above-mentioned composite separator for the lithium ion battery.

In an embodiment, the disclosure provides a lithium ion battery. The lithium ion battery includes a composite separator for the lithium ion battery, the composite separator for the lithium ion battery includes inorganic particles and a binder, the binder is less than 5 wt % of the composite separator, and the inorganic particles consists of first particles and second particles.

Optionally, the first particle and the second particle have different particle sizes.

Optionally, the first particle has a first size, and a particle size of the first particle with the first size is represented by a radius r. Preferably r is 20-100 nm.

Optionally, the first particles are made of one or more of egg shells, duck eggshells, goose eggshells, and other bird/amphibian eggshells.

Optionally, the second particles are particles of natural organic shells with a second size, and a particle size of the second particle with the second size is represented by a radius r′. Preferably, r′ meets a relationship of: (2\sqrt{3}/3−1)<(r′/r)<(\sqrt{6}/2−1). Preferably, a ratio of the volume of the second particles to the volume of the first particles is 2-5:100.

It should be noted that the radius r may be a statistical average of the radii of the first particles; the radius r′ may be a statistical average of the radii of the second particles.

Optionally, the second particles are made of natural organic shells, preferably seashells, and/or abaloneshells.

Optionally, by crushing, ball milling, or grinding, the first particles of a corresponding size r and the second particles of a corresponding size r′ are obtained.

Optionally, the first particles and/or the second particles are modified by dipping, coating, etc. after being crushed and ball milled to a specified diameter range.

Optionally, the first particles are laid to form a first particle layer, and the second particles are embedded in the interspaces of the laid or densely stacked first particles, and the radii meet the relationship of: (2\sqrt{3}/3−1)<(r′/r).

Optionally, the first particles are densely stacked, and the radius of the second particles meets the relationship of: (r′/r)<(\sqrt{6}/2−1). Preferably, the amount of the binder is not more than 5 wt %, and the binder is preferably an amphoteric binder, preferably amphoteric polyacrylamide.

In an embodiment, the disclosure provides a method for preparing a composite separator for a lithium ion battery.

Specifically, the method for preparing the composite separator for the lithium ion battery includes the following steps:

S1, preparing first particles and second particles for raw materials, by selecting, crushing and ball milling eggshells to the first particles with a radius of r, and selecting, crushing and ball milling seashells to the second particles with a radius of r′, wherein r and r′ meet a relationship of: (2\sqrt{3}/3−1)<(r′/r)<(\sqrt{6}/2−1).

S2, preparing a paste, including: mixing 100 parts by volume of the first particles, 2-5 parts by volume of the second particles, and 2-4 wt % binder, ultrasonically dispersing in deionized water, and ball milling for 5-20 minutes to prepare the paste; wherein the binder is amphoteric polyacrylamide, and a concentration of the binder is 0.1-0.3 g/L.

S3, preparing the composite separator by solution casting method, including: pouring the prepared paste on a horizontal and clean glass, adjusting a thickness of the paste with a scraper, and spreading the paste evenly on the glass.

S4, drying at 40-70° C. for 2-5 hours; and then soaking in water for 10-30 minutes.

S5, peeling off the composite separator from the glass, drying the composite separator at 40-70° C. for 5-20 hours, and cutting the composite separator into a size required by the lithium ion battery.

Optionally, the thickness of the composite separator after drying is 10-30 μm.

Optionally, the first particles are made of one or more of egg shells, duck eggshells, goose eggshells, and other bird/amphibian eggshells.

Optionally, the second particles are made of natural organic shells, preferably seashells, and/or abaloneshells.

Optionally, the first particle has a first size, the first size is represented by a radius r, and r is preferably 20-100 nm.

Optionally, the second particles have a second size, the second size is represented by a radius r′. Preferably, r′ and r meet the relationship of: (2\sqrt{3}/3−1)<(r′/r)<(\sqrt{6}/2−1). Preferably, a ratio of the volume of the second particles to the volume of the first particles is 2-5:100.

It should be noted that the radius r may be a statistical average of the radii of the first particles; the radius r′ may be a statistical average of the radii of the second particles.

Optionally, the binder is amphoteric polyacrylamide, and a concentration of the binder is preferably 0.1-0.3 g/L.

Beneficial effects: in the solution, the first particles and the second particles are combined to form an integrated composite separator material for a lithium ion battery. By using less binder, the inorganic material will not fall off, and the particle materials play a full role. Compared with the lithium ion battery inorganic separator in the prior art, the solution has the technical effects of high stability, strong high temperature resistance, good thickness control, and preventing the binder from blocking the pores, and solves the technical problem that, in the prior art, the inorganic particles are relatively large and need to use more binders, and the problem that large gaps among inorganic particles affect the performance of lithium ion battery. Due to the above structure in the solution, it is not easy to block the gaps of the separator, and the separator has high ion mobility, ion conductivity, chemical stability, and thermal stability.

### EXAMPLE 1

Preparation of the Separator

S1, preparing first particles and second particles for raw materials, by selecting, crushing and ball milling egg shells to the first particles with a radius of r, and selecting, crushing and ball milling seashells to the second particles with a radius of r′, r=50 nm and r′=10 nm.

S2, preparing a paste, including: mixing 98 parts of egg shell powder, 2 parts of seashell powder, and 3.5 wt % amphoteric polyacrylamide, dispersing in water, and ball milling for 5 minutes to prepare the paste for later use; wherein the concentration of the amphoteric polyacrylamide is 0.2 g/L.

S3, pouring the prepared paste on a horizontal and clean glass, adjusting the thickness of the paste with a scraper, and spreading the paste evenly on the glass.

S4, drying at 40-70° C. for 2-5 hours; and then soaking in water for 10-30 minutes.

S5, peeling off the composite separator from the glass, drying the composite separator at 40-70° C. for 5-20 hours, and cutting the composite separator into a size required by the lithium ion battery.

The prepared separator material is a sample S1.

### EXAMPLE 2

Preparation of the Separator

S1, preparing first particles and second particles for raw materials, by selecting, crushing and ball milling egg shells to the first particles with a radius of r, and selecting, crushing and ball milling seashells to the second particles with a radius of r′, r=100 nm and r′=10 nm.

S2, preparing a paste, including: mixing 98 parts of egg shell powder, 2 parts of seashell powder, and 3.5 wt % amphoteric polyacrylamide, dispersing in water, and ball milling for 5 minutes to prepare the paste for later use; wherein the concentration of the amphoteric polyacrylamide is 0.2 g/L.

S3, pouring the prepared paste on a horizontal and clean glass, adjusting the thickness of the paste with a scraper, and spreading the paste evenly on the glass.

S4, drying at 40-70° C. for 2-5 hours; and then soaking in water for 10-30 minutes.

S5, peeling off the composite separator from the glass, drying the composite separator at 40-70° C. for 5-20 hours, and cutting the composite separator into a size required by the lithium ion battery.

The prepared separator material is a sample S2.

### EXAMPLE 3

Preparation of the Separator

S1, preparing first particles and second particles for raw materials, by selecting, crushing and ball milling CaCO3 particles to the first particles with a radius of r, and selecting, crushing and ball milling seashells to the second particles with a radius of r′, r=50 nm and r′=10 nm.

S2, preparing a paste, including: mixing 98 parts of CaCO3 particles, 2 parts of seashell powder, and 3.5 wt % amphoteric polyacrylamide, dispersing in water, and ball milling for 5 minutes to prepare a first particle paste for later use; wherein the concentration of the amphoteric polyacrylamide is 0.2 g/L.

S3, pouring the prepared paste on a horizontal and clean glass, adjusting the thickness of the paste with a scraper, and spreading the paste evenly on the glass.

S4, drying at 40-70° C. for 2-5 hours; and then soaking in water for 10-30 minutes.

S5, peeling off the composite separator from the glass, drying the composite separator at 40-70° C. for 5-20 hours, and cutting the composite separator into a size required by the lithium ion battery.

The prepared separator material is a sample S3.

### EXAMPLE 4

Preparation of the Separator

S1, preparing first particles and second particles for raw materials, by selecting CaCO3 particles with a radius of r as the first particles, and selecting Al2O3 particles with a radius of r′ as the second particles, r=50 nm and r′=10 nm.

S2, preparing a paste, including: mixing 98 parts of first particles, 2 parts of second particles, and 3.5 wt % polyvinylidene fluoride, dispersing in water, and ball milling for 5 minutes to prepare the paste for later use; wherein the concentration of the polyvinylidene fluoride is 0.2 g/L.

S3, pouring the prepared paste on a horizontal and clean glass, adjusting the thickness of the paste with a scraper, and spreading the paste evenly on the glass.

S4, drying at 40-70° C. for 2-5 hours; and then soaking in water for 10-30 minutes.

S5, peeling off the composite separator from the glass, drying the composite separator at 40-70° C. for 5-20 hours, and cutting the composite separator into a size required by the lithium ion battery.

The prepared separator material is a sample S4.

### EXAMPLE 5

Preparation of the Separator

S1, preparing first particles and second particles for raw materials, by selecting, crushing and ball milling egg shells to the first particles with a radius of r, and selecting, crushing and ball milling seashells to the second particles with a radius of r′, r=50 nm and r′=10 nm.

S2, preparing a paste, including: mixing 98 parts of first particles, 2 parts of seashell powder, and 3.5 wt % styrene butadiene rubber, dispersing in water, and ball milling for 5 minutes to prepare a first particle paste for later use; wherein the concentration of the styrene butadiene rubber is 0.2 g/L.

S3, pouring the prepared paste on a horizontal and clean glass, adjusting the thickness of the paste with a scraper, and spreading the paste evenly on the glass.

S4, drying at 40-70° C. for 2-5 hours; and then soaking in water for 10-30 minutes.

S5, peeling off the composite separator from the glass, drying the composite separator at 40-70° C. for 5-20 hours, and cutting the composite separator into a size required by the lithium ion battery.

The prepared separator material is a sample S5.

### EXAMPLE 6

Preparation of the separator

S1, preparing first particles and second particles for raw materials, by selecting, crushing and ball milling egg shells to the first particles with a radius of r, and selecting, crushing and ball milling seashells to the second particles with a radius of r′, r=50 nm and r′=10 nm.

S2, preparing a paste, including: mixing 98 parts of first particles, 2 parts of seashell powder, and 3.5 wt % polyvinylidene fluoride, dispersing in water, and ball milling for 5 minutes to prepare the paste for later use; wherein the concentration of the polyvinylidene fluoride is 0.2 g/L.

S3, pouring the prepared paste on a horizontal and clean glass, adjusting the thickness of the paste with a scraper, and spreading the paste evenly on the glass.

S4, drying at 40-70° C. for 2-5 hours; and then soaking in water for 10-30 minutes.

S5, peeling off the composite separator from the glass, drying the composite separator at 40-70° C. for 5-20 hours, and cutting the composite separator into a size required by the lithium ion battery.

The prepared separator material is a sample S6.

### EXAMPLE 7

S1, preparing first particles and second particles for raw materials, by selecting, crushing and ball milling egg shells to the first particles with a radius of r, and selecting, crushing and ball milling seashells to the second particles with a radius of r′, r=50 nm and r′=10 nm.

S2, preparing a paste, including: mixing 98 parts of first particles, 2 parts of seashell powder, and 8 wt % amphoteric polyacrylamide, dispersing in water, and ball milling for 5 minutes to prepare the paste for later use; wherein the concentration of the amphoteric polyacrylamide is 0.2 g/L.

S3, pouring the prepared paste on a horizontal and clean glass, adjusting the thickness of the paste with a scraper, and spreading the paste evenly on the glass.

S4, drying at 40-70° C. for 2-5 hours; and then soaking in water for 10-30 minutes.

S5, peeling off the composite separator from the glass, drying the composite separator at 40-70° C. for 5-20 hours, and cutting the composite separator into a size required by the lithium ion battery separator as required.

The prepared separator material is a sample S7.

TABLE 1
Properties of separators in Examples 1 to 7

| | thickness of | air | areal | peel | shrinkage | surface | liquid | liquid | breakdown |
|---|---|---|---|---|---|---|---|---|---|
| | the coating | permeability | density | strength | rate (%) | resistance | absorbency | retentivity | voltage |
| sample | (um) | (s/100 mL) | (g/m²) | (N/m) | (150° C. 1 h) | (Ω/cm²) | (g/m²) | (g/m²) | (kV) |
| S1 | 25 | 280 | 4.5 | 127 | 4 | 1.20 | 5.0 | 4.8 | 1.8 |
| S2 | 37 | 110 | 5.2 | 90 | 5 | 1.29 | 4.8 | 3.9 | 1.5 |
| S3 | 24 | 190 | 4.3 | 20 | 5 | 1.31 | 3.7 | 3.9 | 1.3 |
| S4 | 28 | 120 | 5 | 12 | 4 | 1.55 | 3.2 | 3.8 | 1.4 |
| S5 | 27 | 330 | 5.5 | 46 | 7 | 1.25 | 4.5 | 4.2 | 1.5 |
| S6 | 27 | 270 | 5.3 | 31 | 5 | 1.22 | 4.9 | 5.1 | 1.8 |
| S7 | 31 | 480 | 5.6 | 180 | 11 | 1.58 | 3.3 | 3.9 | 1.5 |

The above description is only the preferred embodiments of the application and are not intended to limit the application. Any modification, equivalent replacement, and improvement made within the spirit and principle of the disclosure shall be included in the protection scope of the application.

What is claimed is:

1. A composite separator for a lithium ion battery, comprising inorganic particles and a binder, the binder being less than 5 wt % of the composite separator, the inorganic particles consisting of first particles and second particles;
wherein the first particles are made of eggshells, the second particles are made of natural organic shells, and the first particles and the second particles meet an expression of:
(2\sqrt{3}/3−1)<(r′/r)<(\sqrt{6}/2−1)
where r represents a radius of the first particles, r is 20-100 nm, r′ represents a radius of the second particles.

2. The composite separator as claimed in claim 1, wherein the first particles are made of bird eggshells and/or reptile eggshells.

3. The composite separator as claimed in claim 2, wherein the first particles are made of egg shells, duck eggshells, or goose eggshells from broken not more than 48 hours.

4. The composite separator as claimed in claim 1, wherein the first particles are made by crushing, ball milling, or grinding the eggshells to the size r, and the second particles are made by crushing, ball milling, or grinding seashells to the size r′.

5. The composite separator as claimed in claim 1, wherein the second particles are made of seashells, and/or abaloneshells.

6. The composite separator as claimed in claim 1, wherein a ratio of the volume of the second particles to the volume of the first particles is 2:100 to 5:100.

7. The composite separator as claimed in claim 1, wherein the first particles are stacked to form a first particle layer, and the second particles are embedded in interspaces of the stacked first particles to form a second particle layer.

8. The composite separator as claimed in claim 1, wherein the binder is an amphoteric binder.

9. The composite separator as claimed in claim 8, wherein the binder is amphoteric polyacrylamide, a concentration of the binder is 0.1-0.3 g/L.

10. A method for preparing a composite separator for a lithium ion battery, comprising:
S1, crushing eggshells to first particles, and crushing seashells to second particles, wherein the first particles and the second particles meet an expression of: (2\sqrt{3}/3−1)<(r′/r)<(\sqrt{6}/2−1), where r represents a radius of the first particles, r is 20-100 nm, r′ represents a radius of the second particles;
S2, dispersing 100 parts by volume of the first particles, 2-5 parts by volume of the second particles, and 2-4 wt % binder in deionized water, and ball milling for 5-20 minutes to prepare a paste;
S3, pouring the prepared paste on a glass plate;
S4, drying the paste on the glass plate at 40-70° C. for 2-5 hours thereby forming a composite separator film; and soaking the composite separator film in water for 10-30 minutes after the drying; and
S5, peeling off the composite separator film from the glass plate, and drying the separator film at 40-70° C. for 5-20 hours.

11. The method as claimed in claim 10, wherein before S2, the method further comprises:
modifying the first particles and/or the second particles by dipping, or coating.

12. The method as claimed in claim 10, wherein S3 further comprises:
adjusting a thickness of the paste with a scraper, and spreading the paste evenly on the glass plate.

13. The method as claimed in claim 10, wherein S5 further comprises:
cutting the composite separator film into a size required by the lithium ion battery, thereby forming the composite separator for the lithium ion battery.

14. The method as claimed in claim 10, wherein a thickness of the separator film after drying in S5 is 10-30 μm.

15. The method as claimed in claim 10, wherein the binder is an amphoteric binder.

16. The method as claimed in claim 15, wherein the binder is amphoteric polyacrylamide, and a concentration of the binder is 0.1-0.3 g/L.

17. The method as claimed in claim 10, wherein the first particles are made of bird eggshells and/or reptile eggshells.

18. The method as claimed in claim 10, wherein the raw material of the first particles is the eggshells from broken not more than 48 hours.

19. The method as claimed in claim 10, wherein a ratio of the volume of the second particles to the volume of the first particles is 2:100 to 5:100.

20. A lithium ion battery, comprising a composite separator, wherein
the composite separator comprises inorganic particles and a binder, the binder is less than 5 wt % of the composite separator, and the inorganic particles consists of first particles and second particles; and
the first particles are made of eggshells, the second particles are made of natural organic shells, and the first particles and the second particles meet an expression of:
(2\sqrt{3}/3−1)<(r′/r)<(\sqrt{6}/2−1)
where r represents a radius of the first particles, r is 20-100 nm, r′ represents a radius of the second particles.
